(19) United States
(12) Patent Application Publication
(10) Pub. No.: US 2019/0114071 A1
(43) Pub. Date: Apr. 18, 2019

(54) DISPLAY CONTROL APPARATUS AND DISPLAY CONTROL METHOD

(71) Applicant: FUJITSU CONNECTED TECHNOLOGIES LIMITED, Kawasaki-shi (JP)

(72) Inventors: Hiroshi Fujino, Fuchu (JP); Miho Kyoya, Kawasaki (JP); Takeshi Ueno, Sapporo (JP); Takanori Harada, Kawasaki (JP); Hirofumi Endo, Sapporo (JP)

(73) Assignee: FUJITSU CONNECTED TECHNOLOGIES LIMITED, Kawasaki-shi (JP)

(21) Appl. No.: 16/156,527

(22) Filed: Oct. 10, 2018

(30) Foreign Application Priority Data
Oct. 12, 2017 (JP) 2017-198600

(51) Int. Cl. G06F 3/0488; G06F 3/0485; G06F 3/0484

(52) U.S. Cl. CPC G06F 3/04883; G06F 3/0485; G06K 9/00006; G06F 2203/04808; G06F 3/04845

(57) ABSTRACT

A display control apparatus includes a memory and a processor coupled to the memory. The processor is configured to perform first executing first display control with respect to a screen, corresponding to a moving quantity of a first operation on a sensor, changing an operation mode with respect to the screen when detecting a second operation different from the first operation on the sensor, and second executing second display control with respect to the screen, corresponding to the moving quantity of the first operation on the screen, after changing the operation mode.

### CROSS-REFERENCE TO RELATED APPLICATION

This application is based upon and claims the benefit of priority of the prior Japanese Patent Application No. 2017-198600, filed on Oct. 12, 2017, the entire contents of which are incorporated herein by reference.

### FIELD

The embodiments discussed herein are related to a display control apparatus and a display control method.

### BACKGROUND

A mobile terminal instanced by a smartphone has hitherto adopted fingerprint authentication using a small-sized fingerprint sensor, and also adopted a technology of detecting a moving operation of user's finger by a small-sized sensor, and scrolling a screen. In recent years, a small-sized sensor is known, the small-sized sensor performing the fingerprint authentication and a scroll operation. It is known that a technology of scrolling the screen through an operation employing a slide sensor equipped in a side surface of the mobile terminal.

### DOCUMENTS OF RELATED ARTS

### Patent Documents

[Patent Document 1] Japanese Laid-open Patent Publication No. 2005-301658

[Patent Document 2] Japanese Laid-open Patent Publication No. 2013-232026

### SUMMARY

According to an aspect of the embodiments, a display control apparatus includes a memory and a processor coupled to the memory. The processor is configured to perform first executing first display control with respect to a screen, corresponding to a moving quantity of a first operation on a sensor, changing an operation mode with respect to the screen when detecting a second operation different from the first operation on the sensor, and second executing second display control with respect to the screen, corresponding to the moving quantity of the first operation on the screen, after changing the operation mode.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a view illustrating a configuration of a whole mobile terminal according to an Example 1;

FIG. 2 is a diagram illustrating an example of a hardware configuration of the mobile terminal according to the Example 1;

FIG. 3 is a logical block diagram of the mobile terminal according to the Example 1;

FIG. 4 is a view for explaining respective operation modes;

FIG. 5 is an explanatory view of a series of flows of switching over an operation mode; and

FIG. 6 is a flowchart illustrating a flow of a switchover process of the operation mode.

### DESCRIPTION OF EMBODIMENTS

Depending on the application, operation is insufficient only scroll operation, and various operations other than scrolling are performed. The technologies given above cause occurrence of switching the mobile terminal from one hand to another hand each time an operation other than the scroll operation is performed, resulting in deteriorated operability.

Examples of a display control apparatus, a display control method and a display control program, which are disclosed by the present application, will hereinafter be described in detail based on the drawings. Note that the embodiments discussed herein are not limited by these Examples. The Examples may be properly combined within a range not causing any contradictions.

### Example 1

[Whole Configuration]

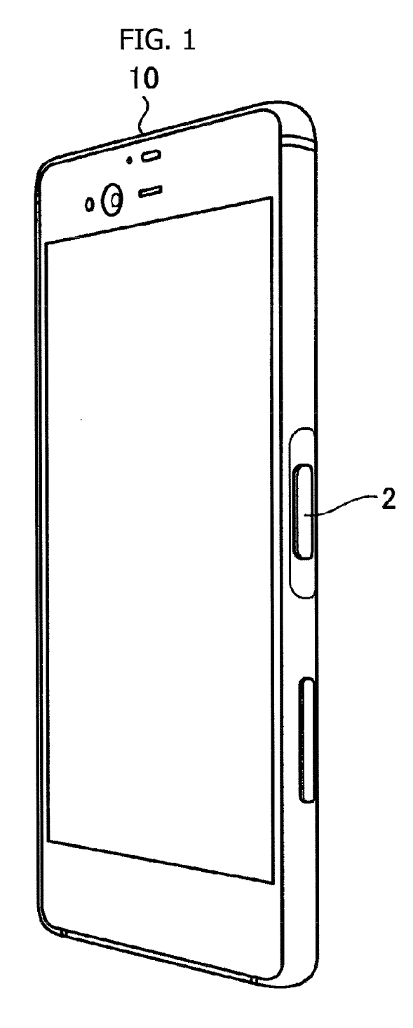

FIG. 1 is a view illustrating a whole configuration of a mobile terminal 10 according to an Example 1. FIG. 1 is a perspective view of the mobile terminal 10. The mobile terminal 10 is one example of the display control apparatus instanced by a smartphone, a tablet terminal, a PDA (Personal Digital Assistant) and a small-sized computer.

As illustrated in FIG. 1, the mobile terminal 10 includes a sensor 2. This sensor 2 is installed in a position to facilitate a user's operation on a side surface of the mobile terminal 10. For example, when the mobile terminal 10 is operated by a right hand of the user, the sensor 2 is installed in such a position that a thumb contacts the mobile terminal 10 or installed in the periphery of this position. When the mobile terminal 10 is operated by a left hand of the user, the sensor 2 is installed in such a position that an index finger contacts the mobile terminal 10 or installed in the periphery of this position. Note that the installing position of the sensor 2 may be set in other portions without being limited to the side surface.

The sensor 2 also performs as a fingerprint sensor to read a fingerprint in addition to the sensor that detects whether the finger contacts. For example, the mobile terminal 10 performs the fingerprint authentication by using the sensor 2, and also the display control of a screen by employing the sensor 2. The sensor 2 is capable of detecting a movement (distance, direction) of the finger.

Specifically, the mobile terminal 10 performs first display control over the screen, corresponding to a moving quantity of a first operation on the sensor 2. The mobile terminal 10, when detecting a second operation different from the first operation on the sensor 2, changes an operation mode for the screen. Thereafter, the mobile terminal 10, after changing the operation mode, performs second display control over the screen, corresponding to the moving quantity of the first operation on the sensor 2.

For instance, the mobile terminal 10, when detecting a swipe operation and a slide operation on the sensor 2 after starting up the terminal, scrolls information to be displayed on the screen. Thereafter, the mobile terminal 10, upon accepting the operation instanced by a double tap on the sensor 2, changes the operation mode to the second operation mode. The mobile terminal 10, when detecting the swipe operation and the slide operation on the sensor 2 after making a change to the second operation mode, enlarges or reduces the information to be displayed on the screen. Thereafter, the mobile terminal 10, upon accepting the operation instanced by the double tap on the sensor 2, changes over the operation mode to the first operation mode.

The mobile terminal 10 is thus enabled to attain both the screen scroll and the enlargement/reduction of the screen display without switching the apparatus from one hand to another hand, and therefore enabled to improve operability when performing the screen control.

[Hardware]

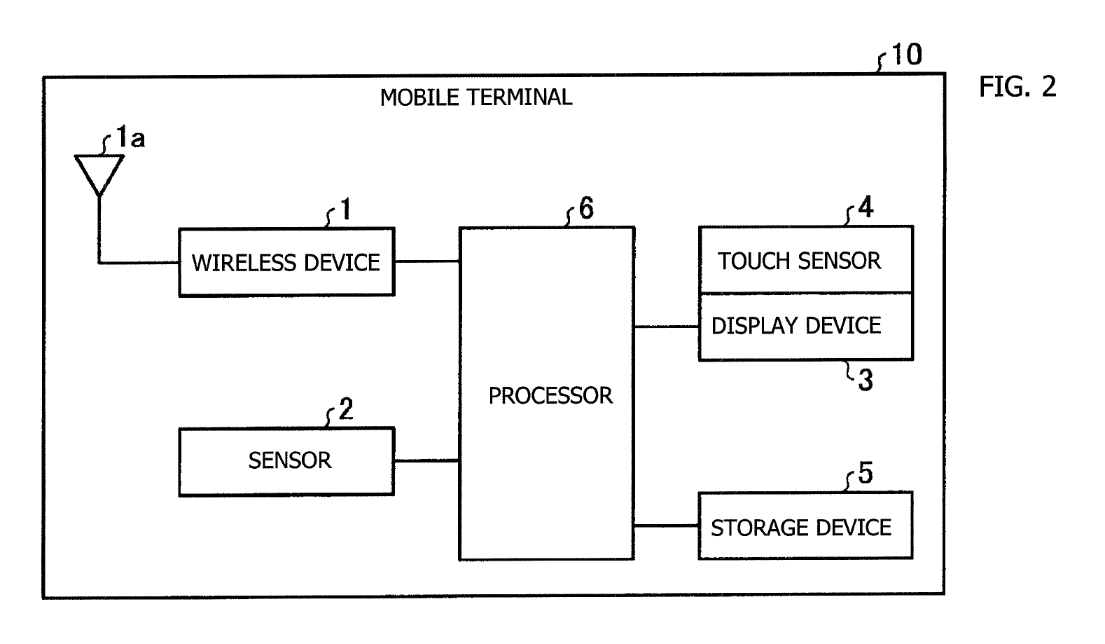

FIG. 2 is a diagram illustrating an example of a hardware configuration of the mobile terminal 10 according to the Example 1. As depicted in FIG. 2, the mobile terminal 10 includes a wireless device 1, the sensor 2, a display device 3, a touch sensor 4, a storage device 5, and a processor 6.

The wireless device 1 performs communications with other smartphones and a base station by using an antenna 1a. The sensor 2 serves as a detection sensor to detect whether the finger contacts and also as a fingerprint sensor to read the fingerprint.

The display device 3, which is exemplified by a display, displays various items of information on an application screen, a Web screen and other equivalent screens. The touch sensor 4 detects a touch operation on the display. The display device 3 and the touch sensor 4 cooperate to attain a touch panel.

The storage device 5 is one example of storage devices instanced by a hard disk and a memory, which store various items of data and various categories of programs. Given as one example of the storage device 5 are: a Random Access Memory (RAM) instanced by a Synchronous Dynamic Random Access Memory (SDRAM); a Read Only Memory (ROM); and a flash memory.

The processor 6 is a processing unit that controls the whole mobile terminal 10 and is, e.g., a Central Processing Unit (CPU). The processor 6 reads, from the hard disk, a program for executing a variety of processes to be described later, deploys the program on the memory, and executes multiple processes for executing the same processes as those of a processing unit to be described later. Given as one example of the processor 6 are the CPU, a Digital Signal Processor (DSP), and Field Programmable Gate Array (FPGA), and a Programmable Logic Device (PLD).

[Logical Configuration]

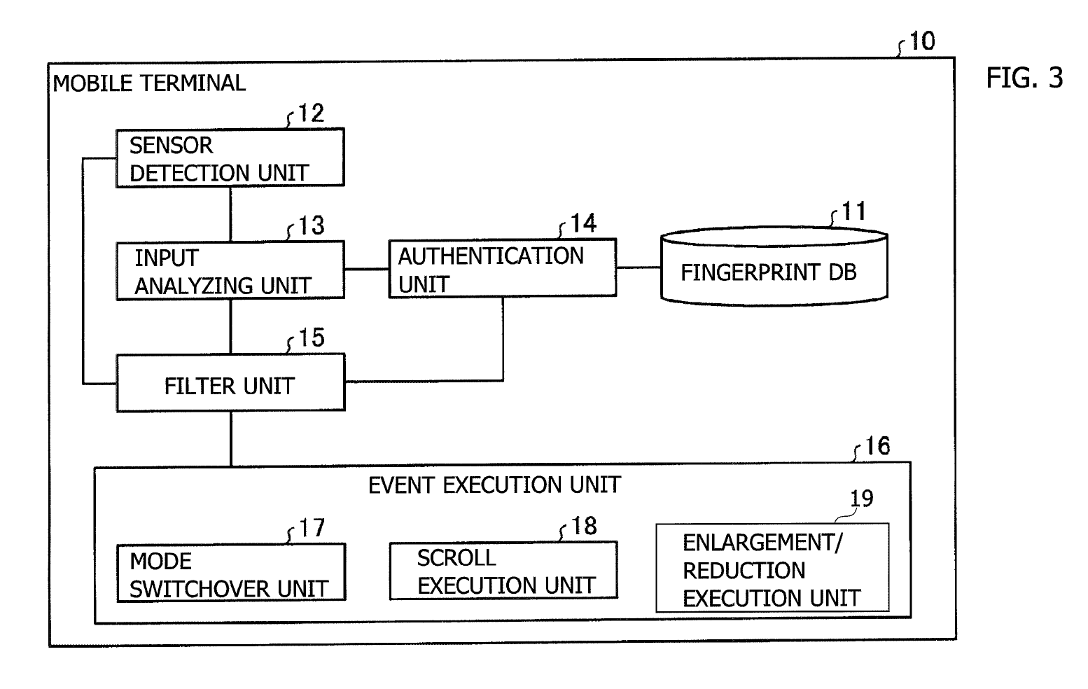

FIG. 3 is a logical block diagram illustrating a logical configuration of the mobile terminal 10 according to the Example 1. As illustrated in FIG. 3, the mobile terminal 10 includes a fingerprint database (DB) 11, a sensor detection unit 12, an input analyzing unit 13, an authentication unit 14, a filter unit 15, and an event execution unit 16.

Note that the fingerprint DB 11 is a database to be stored in the storage device instanced by the memory and the hard disk. Each of the sensor detection unit 12, the input analyzing unit 13, the authentication unit 14, the filter unit 15 and the event execution unit 16 is one example of an “electronic circuit” possessed by the processor 6, and is also one example of a process to be executed by the processor 6.

The fingerprint DB 11 is the database to store images of authentic fingerprints of users. For example, the fingerprint DB 11 stores the fingerprint images of the individual users by being associated with valid users who use the mobile terminals 10.

The sensor detection unit 12 is a processing unit to detect a touch to and an operation on the sensor 2. For example, the sensor detection unit 12 detects a signal that varies based on a finger touch to the sensor 2, and outputs the signal serving as a detection signal to the filter unit 15. To be specific, when detecting the detection signal having a value equal to or larger than a fixed value, it may be determined that the user touches the sensor 2. More specifically, the sensor detection unit 12 detects the user's operation when the detection signal over the fixed value touches is detected continuously for a predetermined period of time. Note that a variety of other methods may be adopted without being limited to an electrostatic sensor to detect a variation in electrostatic capacity and a pressure sensitive sensor to detect a variation in pressure.

The input analyzing unit 13 is a processing unit to analyze a status of the mobile terminal 10 when the sensor detection unit 12 detects the user's operation on the sensor 2. For example, the input analyzing unit 13 determines whether the mobile terminal 10 is in an application startup-enabled status after the fingerprint authentication has been approved. The input analyzing unit 13 instructs the authentication unit 14 to execute the fingerprint authentication when in a pre-execution status of the fingerprint authentication, and instructs the event execution unit 16 to execute an operation when in a post-approval status of the fingerprint authentication.

The authentication unit 14 is a processing unit to execute the fingerprint authentication. For instance, the authentication unit 14, upon being instructed by the input analyzing unit 13 to execute the fingerprint authentication, acquires via the sensor 2 a fingerprint of the finger touching the sensor 2. The authentication unit 14 approves the authentication when the acquired fingerprint is registered in the fingerprint DB11, and instructs the event execution unit 16 to execute the operation. Whereas when the acquired fingerprint is not registered in the fingerprint DB11, the authentication unit 14 rejects the authentication. Note that fingerprints of plural users are registered, in which case the user is also enabled to previously select which user is targeted on the authentication.

The filter unit 15 is a processing unit to eliminate a noise from a detection signal detected from the sensor detection unit 12. For example, the filter unit 15 eliminates the noise by applying a filter to eliminate the noises, a smoothing filter to perform smoothing and other equivalent filters to the detection signal detected by the sensor detection unit 12. The filter unit 15 outputs the detection signal after the noise has been eliminated therefrom to the event execution unit 16.

The event execution unit 16 is a processing unit to execute, when an operation executing instruction is given from each of the processing units, a process corresponding to the inputted user's operation. The event execution unit 16 includes a mode switchover unit 17, a scroll execution unit 18, and an enlargement/reduction execution unit 19.

The mode switchover unit 17 is a processing unit to determine a user's operation mode and to execute switching over the operation mode. Specifically, the mode switchover unit 17, upon detecting a specified operation instanced by double taps via the sensor 2, performs the switchovers of a first operation mode (scroll mode) and a second operation mode (enlargement/reduction mode).

For instance, the mode switchover unit 17 determines that the mobile terminal 10 operates in the first operation mode (scroll mode) in a default status when started up. In this scroll mode, the mode switchover unit 17 inputs the detection signal detected by the sensor detection unit 12 to the scroll execution unit 18.

The mode switchover unit 17, when detecting the double tap operation via the sensor detection unit 12 during the operation in the scroll mode, switches over the mode to the second operation mode (enlargement/reduction mode) from the first operation mode (scroll mode). In this enlargement/reduction mode, the mode switchover unit 17 inputs the detection signal detected by the sensor detection unit 12 to the enlargement/reduction execution unit 19.

The mode switchover unit 17, upon detecting the double tap operation via the sensor detection unit 12 during the operation in the enlargement/reduction mode, switches over the mode to the first operation mode (scroll mode) from the second operation mode (enlargement/reduction mode). Thus, the mode switchover unit 17 switches over the operation mode upon detecting the double tap.

The scroll execution unit 18 is a processing unit to scroll the screen display when the sensor detection unit 12 detects the swipe operation on the sensor 2 during the operation in the scroll mode. Specifically, the scroll execution unit 18 scrolls the screen upward when the user's finger swipes the sensor 2 upward, and scrolls the screen downward when the user's finger swipes the sensor 2 downward. Note that the upward and downward directions with respect to the sensor 2 may be preset. The upward and downward directions may also be dynamically set in accordance with the display screen actually displayed on the mobile terminal 10.

The enlargement/reduction execution unit 19 is a processing unit to enlarge or reduce the screen display when the sensor detection unit 12 detects the swipe operation on the sensor 2 during the operation in the enlargement/reduction mode. To be specific, the enlargement/reduction execution unit 19 enlarges the screen display when the user's finger swipes the sensor 2 upward, and reduces the screen display when the user's finger swipes the sensor 2 downward. Note that the reducing operation embraces both of a case of returning the enlarged screen to an original size of screen and a case of displaying the screen much smaller than the original size of screen.

[Explanation of Operation Mode]

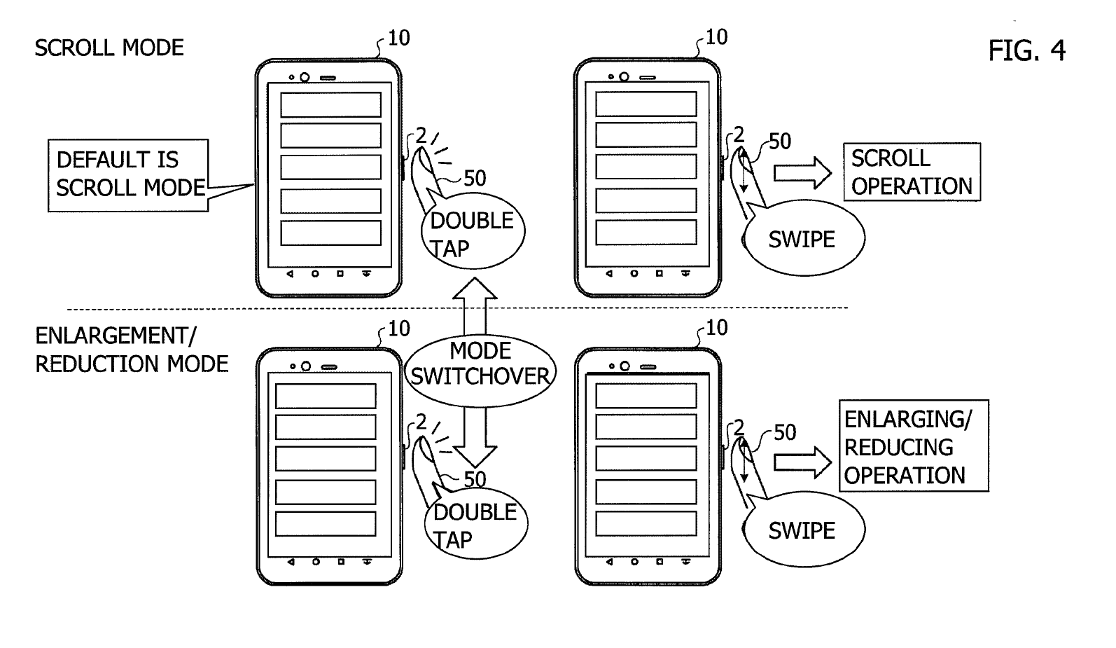

FIG. 4 is a view for explaining the respective operation modes. As depicted in FIG. 4, the mode switchover unit 17 causes the terminal to operate in the scroll mode in the default status when starting up the terminal. In this status, the scroll execution unit 18, upon detecting the swipe operation on the sensor 2 by a finger 50, executes the scroll operation on the screen.

The mode switchover unit 17 switches over the operation mode to the enlargement/reduction mode upon detecting the double tap on the sensor 2 during the operation in the scroll mode. In this status, the enlargement/reduction execution unit 19, upon detecting the swipe operation of the finger 50 on the sensor 2, executes the operation of enlarging and reducing the screen. The mode switchover unit 17 switches over the operation mode to the scroll mode upon detecting the double tap of the finger 50 on the sensor 2.

Thus, the mobile terminal 10 executes switching over the mode upon the double tap of the user's finger 50. The mobile terminal 10, when detecting the swipe on the sensor 2, performs the screen control corresponding to the present operation mode.

[Example of Screen Control]

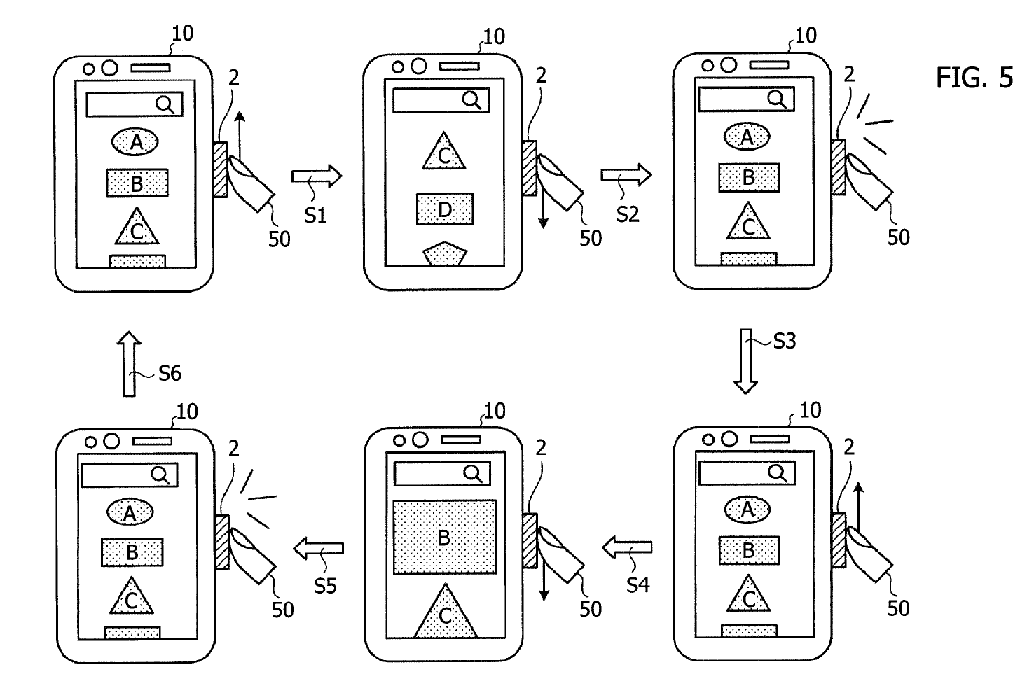

FIG. 5 is an explanatory view of a series of flows of switching over the operation mode. As illustrated in FIG. 5, the mobile terminal 10 operates in the scroll mode when started up, and therefore, when detecting the upward swipe of the finger 50 on the sensor 2 in this status, causes the information displayed on the display to be scrolled upward (51). As a result, in the example of FIG. 5, a status of contents A, B, C being displayed transitions to a status of contents C, D being displayed.

Subsequently, the mobile terminal 10, when detecting the downward swipe of the finger 50 on the sensor 2 in a status of keeping the scroll mode, causes the information displayed on the display to be scrolled downward (S2). As a consequence, in the example of FIG. 5, the status of contents C, D being displayed transitions to the status of contents A, B, C being displayed, thus returning to the original status.

Thereafter, the mobile terminal 10 changes the operation mode to the enlargement/reduction mode when detecting the double tap of the finger 50 on the sensor 2 in the status of the scroll mode (S3). Herein, the operation mode is changed, and hence the contents A, B, C are still displayed without any change of the screen display.

The mobile terminal 10, upon detecting the upward swipe of the finger 50 on the sensor 2 after the change to the enlargement/reduction mode, causes the information displayed on the display to be displayed in enlargement (S4). As a result, in the example of FIG. 5, the contents A, B, C are displayed in enlargement, and therefore such a status occurs that the content A disappears from the screen, while the contents B, C are displayed.

Subsequently, the mobile terminal 10, upon detecting the downward swipe of the finger 50 on the sensor 2 in a status of keeping the enlargement/reduction mode, causes the information displayed on the display to be scrolled downward (S5). As a consequence, in the example of FIG. 5, each of the contents displayed in enlargement returns to the original size, and hence such a status occurs that the contents A, B, C are displayed, thus returning to the original status.

Thereafter, the mobile terminal 10 changes the operation mode to the scroll mode when detecting the double tap of the finger 50 on the sensor 2 in the status of the enlargement/reduction mode (S6). Herein, the operation mode is changed, and hence the contents A, B, C are still displayed without any change of the screen display.

[Flow of Switchover Process of Operation Mode]

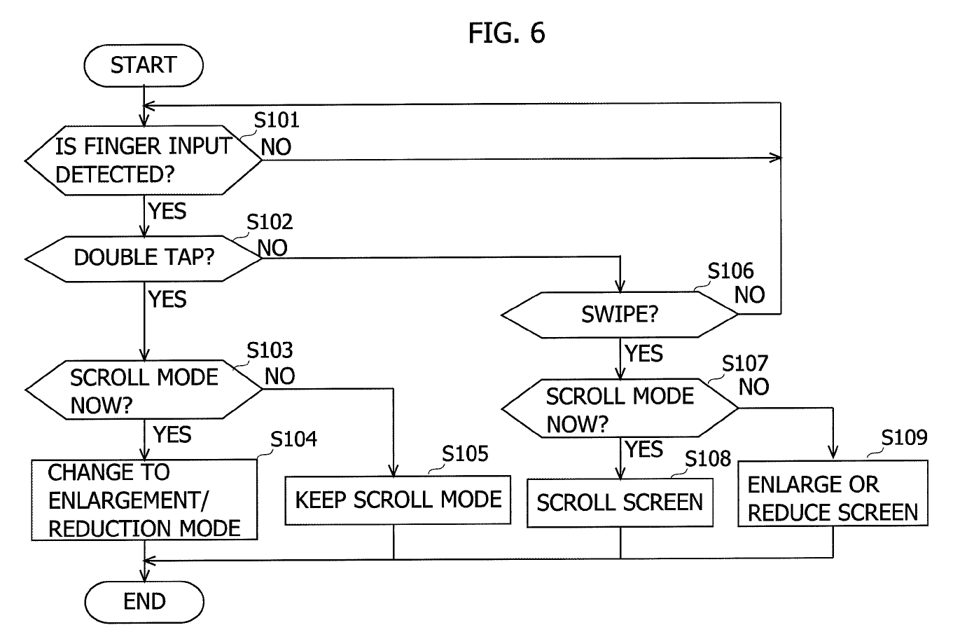

FIG. 6 is a flowchart illustrating a flow of a switchover process of the operation mode. As illustrated in FIG. 6, the event execution unit 16, when detecting a finger input (operation) (S101: Yes), determines whether the detected operation is the double tap (S102).

The event execution unit 16, when the detected operation is the double tap (S102: Yes), determines whether to be now in operation in the scroll mode (S103).

Herein, the event execution unit 16 changes the operation mode to the enlargement/reduction mode (S104) when in operation in the scroll mode (S103: Yes), and keeps the present scroll mode whereas when not in operation in the scroll mode (S103: No) (S105).

On the other hand, when the detected operation is not the double tap in S102 (S102: No), the event execution unit 16 determines whether the detected operation is the swipe (S106). Herein, when the detected operation is not the swipe (S106: No), the event execution unit 16 loops back to S101 and iterates the subsequent processes.

Whereas when the detected operation is the swipe (S106: Yes), the event execution unit 16 determines whether the terminal is now in operation in the scroll mode (S107).

Herein, the event execution unit 16 scrolls the screen (S108) when in operation in the scroll mode (S107: Yes), and enlarges or reduces the screen (S109) when not in operation in the scroll mode but in operation in the enlargement/reduction mode (S107: No).

[Effect]

As described above, the mobile terminal 10 attains both of sliding and enlarging/reducing the screen by simple operations in a way that switches over the operation mode by the double tap in the operation using the sensor 2 equipped on the side surface of the terminal. The mobile terminal 10 is thereby enabled to improve operability when performing the screen control.

### Example 2

The Example of the embodiment has been described so far, and the embodiment may, however, be carried out in a variety of different modes other than the Example described above. Different Examples will hereinafter be described.

[Switchover Action]

In the Example described above, an action of the mode switchover has been described by exemplifying the double tap, and the action is not, however, limited to the double tap. For example, hold-down and other equivalent actions may arbitrarily be set. Note that any regions instanced by regions other than the finger of the hand may be adopted for the touch operation as far as being an indication region enabling the user's operation to be detected without being limited to the finger. The operation of being allocated to the respective switchover target modes may be arbitrarily set and changed.

[Default Mode]

The Example described above has exemplified the instance of operating in the scroll mode when started up, and the terminal may also be operated in the enlargement/reduction mode without being limited to this scroll mode. With respect to the operation mode, a variety of operations instanced by a page switchover, a startup of an application, and transmission/reception of a mail may also be adopted without being limited to the scrolling and the enlarging/reducing operations.

[System]

The processing procedure, the control procedure, the specific nomenclatures and the information containing the various items of data and parameters given in the specification and the drawings may be arbitrarily changed, unless otherwise specified.

The respective components of each of the illustrated devices are those functional and conceptual, but need not to be necessarily configured physically as illustrated. That is to say, the specific modes of dispersing and integrating of the respective devices are not limited to those illustrated herein. In other words, the whole or a part of the components may be configured by being dispersed or integrated functionally or physically on an arbitrary basis, corresponding to multiple loads and usage conditions. The whole or a part of the processing functions performed in the respective devices may be attained by a CPU and a program analyzed and run by the CPU, or may be attained as wired logic based hardware components.

According to embodiments, it is feasible to improve the operability when performing the screen control.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display control apparatus comprising:
a memory; and
a processor coupled to the memory, the processor configured to perform:
first executing first display control with respect to a screen,
corresponding to a moving quantity of a first operation on a sensor;
changing an operation mode with respect to the screen when detecting a second operation different from the first operation on the sensor; and
second executing second display control with respect to the screen, corresponding to the moving quantity of the first operation on the screen, after changing the operation mode.

2. The display control apparatus according to claim 1, wherein the first executing includes executing a scroll process on the screen, corresponding to a moving quantity of a swipe operation on the sensor,
the changing includes changing the operation mode when detecting a double tap operation different from the swipe operation on the sensor, and
the second executing includes an enlarging/reducing process with respect to the screen, corresponding to the moving quantity of the swipe operation on the sensor, after changing the operation mode.

3. The display control apparatus according to claim 1, wherein the processor is further configured to perform extracting the moving quantity of the first operation by eliminating a noise from an input detected by the sensor.

4. The display control apparatus according to claim 1, wherein the sensor is a sensor capable of detecting a fingerprint, and is installed on a side surface of the display control apparatus.

5. A display control method executed by a computer, the display control method comprising:
first executing first display control on a screen, corresponding to a moving quantity of a first operation on a sensor;
changing an operation mode with respect to the screen when detecting a second operation different from the first operation on the sensor; and
second executing second display control with respect to the screen, corresponding to the moving quantity of the first operation on the screen, after changing the operation mode.

6. A non-transitory computer-readable recording medium having stored therein a program of a computer including a processor and a memory, the program to cause the processor to perform:
first executing first display control with respect to a screen, corresponding to a moving quantity of a first operation on a sensor;
changing an operation mode with respect to the screen when detecting a second operation different from the first operation on the sensor; and
second executing second display control with respect to the screen, corresponding to the moving quantity of the first operation on the screen, after changing the operation mode.
